(19) United States
(12) Patent Application Publication
(10) Pub. No.: US 2011/0192551 A1
(43) Pub. Date: Aug. 11, 2011

(54) WINDOW BLIND ASSEMBLY

(76) Inventor: Hugh Rance, Flushing, NY (US)

(21) Appl. No.: 13/061,039

(22) PCT Filed: Aug. 27, 2008
(86) PCT No.: PCT/US08/74448

§ 371 Date: Mar. 24, 2011

(51) Int. Cl. E06B 9/386; E06B 9/26

(52) U.S. Cl. 160/127; 160/236

(57) ABSTRACT

A window blind assembly adapted so that, when covering a window to a room, a person inside the room can see out, but a person outside the room cannot see in. The assembly includes alternating first and second slats. The first slats are semi-mirrored and semi-transparent. A source of illumination is provided to illuminate first major surfaces of the second slats. The first and second slats are arranged so that light reflected by the first major surfaces of the second slats is at least partially reflected, in a first direction, by the first slats.

### CROSS-REFERENCE TO RELATED APPLICATION(S)

This application is a continuation-in-part of and claims the benefit of and priority to U.S. patent application Ser. No. 11/556,166, filed Nov. 2, 2006, the disclosure of which is incorporated herein by reference in its entirety.

### FIELD OF THE INVENTION

The present application relates to a window blind assembly and, more particularly, to a window blind assembly that, when extended across a window in a room, can enable a person inside the room to see out through the window blind assembly and simultaneously prevent a different person outside the room from seeing in through the window blind assembly.

### BACKGROUND

A window blind is a window covering with slats. The angles of the slats may be varied so as to vary the amount of light admitted. Window blinds can provide some degree of privacy and can be decorative as well.

### SUMMARY OF THE INVENTION

In one aspect, a window blind assembly includes alternating first and second slats. The first slats are semi-mirrored and semi-transparent. A source of illumination is provided to illuminate first major surfaces of the second slats. The first and second slats are arranged so that light reflected by the first major surfaces of the second slats is at least partially reflected, in a first direction, by the first slats. Typically, light reflected by the first major surfaces is substantially reflected, in the first direction, by the first slats.

In some implementations, the first slats are arranged relative to the second slats so that the reflected by the second major surfaces of the second slats, opposite the first major surfaces, is at least partially reflected by the first slats in a second direction that is different from the first direction.

According to certain embodiments, the first major surfaces are lighter in color and/or more reflective than the second major surfaces. Accordingly, under similar lighting conditions, the first major surfaces would appear brighter than the second major surfaces.

The source of illumination, in some embodiments, is arranged to illuminate the first major surfaces of the second slats so that the first slats to appear substantially reflective when viewed from the first direction and to cause the first slats to appear substantially transparent when viewed from a second direction. The second direction may be opposite the first direction. For example, if the window blind assembly were positioned in a window in a room, the first direction may be through the window to the outside and the second direction may be into the room.

The source of illumination may be a lighting fixture. In some implementations, the amount of illumination provided by the source of illumination is adjustable. Indeed, the amount of illumination provided by the source of illumination may be automatically adjustable based on ambient lighting conditions at one side of the window blind assembly. Alternatively, the amount of illumination provided by the source of illumination may be adjustable manually, for example, by a wall mounted switch or a switch mounted to the window frame. The amount of illumination provided by the source of illumination may be automatically adjustable based on ambient lighting conditions at one side of the window blind assembly relative to ambient lighting conditions at an other side of the window blind assembly.

In some implementations, one or more sensors are provided to sense the ambient lighting conditions on one or more sides of the window blind assembly (e.g., ambient light conditions outdoors and/or ambient light conditions inside a room).

In a typical embodiment, adjacent first and second slats are substantially in contact with one another. This is to prevent someone outside the room from being able to see through spaces between the first and second slats. If adjacent first and second slats are not actually in contact with one another, it is desirable that they be very close to one another. In certain embodiments, adjacent first and second slats are connected to one another via hinged connections. In certain embodiments, adjacent first and second slats, in their deployment, are at angles that are controlled by their support element.

The window blind assembly of claim 1 wherein each first slat is arranged substantially perpendicular to a lengthwise axis of the window blind assembly and wherein at least some of the second slats extend from a first end of one of the first slats to a second, opposite end of a different one of the first slats. Typically, adjacent first and second slats form an angle relative to one another that is less than 90° and, more preferably, less than 45°.

In another aspect, a window blind assembly includes alternating first and second slats. The first slats are semi-mirrored and semi-transparent. The second slats have respective first and second surfaces and the first surfaces are lighter in color than the second surfaces. The first slats are arranged relative to the second slats so that light reflected by the first surfaces of the second slats is at least partially reflected, in a first direction, by the first slats. In some implementations, the window blind assembly includes a light fixture to illuminate the first surfaces of the second slats.

Typically, the first slats are arranged relative to the second slats so that the second surfaces of the second slats are at least partially reflected by the first slats in a second direction that is different from the first direction. Moreover, it is typical that adjacent first and second slats form an angle relative to one another that is less than 45°.

In certain embodiments, the first and second surfaces face in opposite directions from one another, are rectangular in shape, and have widths substantially wider than edges of the slats, which extend between the first and second surfaces.

In yet another aspect, a window blind assembly includes a support element coupled to a window frame. Alternating first and second slats extend from the support element across the window. The first slats are semi-mirrored and semi-transparent, and the second slats have first and second major surfaces. The first major surfaces of the second slats are lighter in color than the second major surfaces of the second slats. A lighting fixture is provided to illuminate the first major surfaces of the second slats. The first and second slats are arranged so that light reflected by the first major surfaces of the second slats is at least partially reflected, in a first direction, by the first slats. The first and second slats are further arranged so that light reflected by the second major surfaces of the second slats is at least partially reflected, in a second direction opposite the first direction, by the first slats. Moreover, the adjacent first and second slats form an angle relative to one another that is less than 45°.

In some implementations, one or more of the following advantages may be present.

A person may enjoy the privacy afforded by a set of closed window blinds, but still be able to see out through the closed window blinds. Additionally, the sun's light may be able to enter through a closed set of blinds.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a view of a window blind assembly at a window.

FIG. 2 is a partial, cross-sectional view of the window blind assembly of FIG. 1.

FIG. 3 is a circuit diagram of a control system for a source of illumination.

FIG. 4 shows a view out through a window.

FIG. 5 includes a cross-sectional view of a window blind assembly and shows the view of FIG. 4 as seen through the window blind assembly.

FIG. 6 includes a cross-sectional view of a window blind assembly and shows a view of the window blind assembly looking from the outside in.

FIG. 7 includes a partial, cross-sectional view of a window blind assembly and shows views to the outside through window blind assembly.

FIG. 8 is a partial, exploded, perspective view of a window blind assembly.

FIG. 9 shows a cross-sectional view of a collapsible window blind assembly in three stages of collapse.

FIG. 10 shows a cross-sectional view of a collapsible window blind assembly in three stages of collapse.

FIG. 11 shows a cross-sectional view of a collapsible window blind assembly in three stages of collapse.

### DETAILED DESCRIPTION

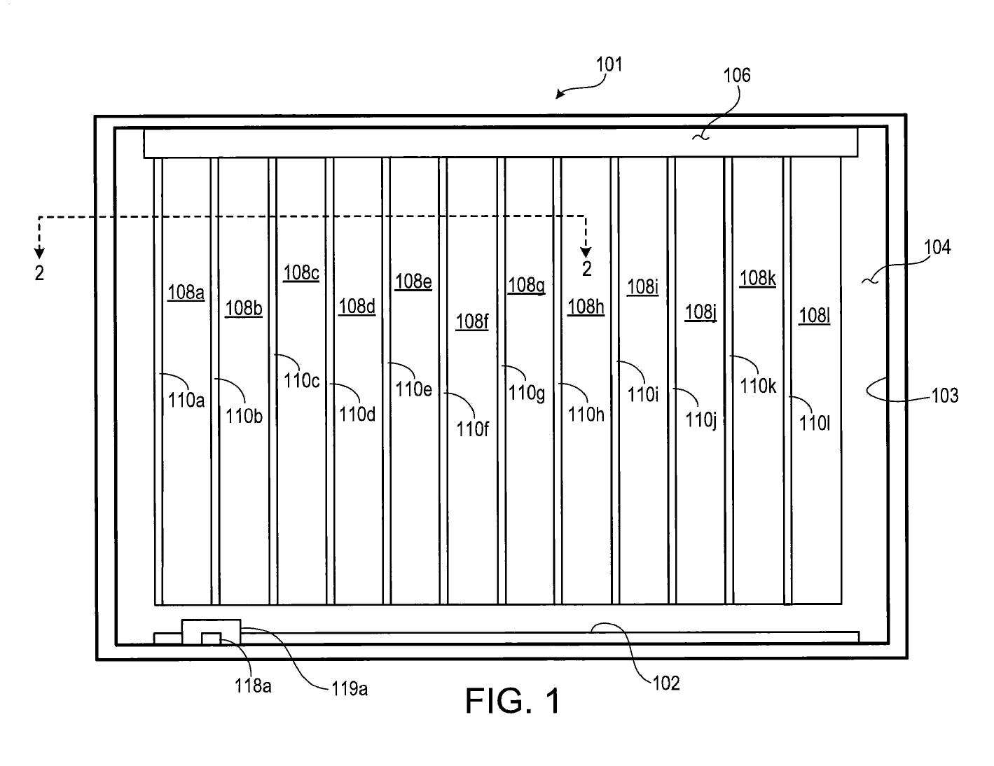

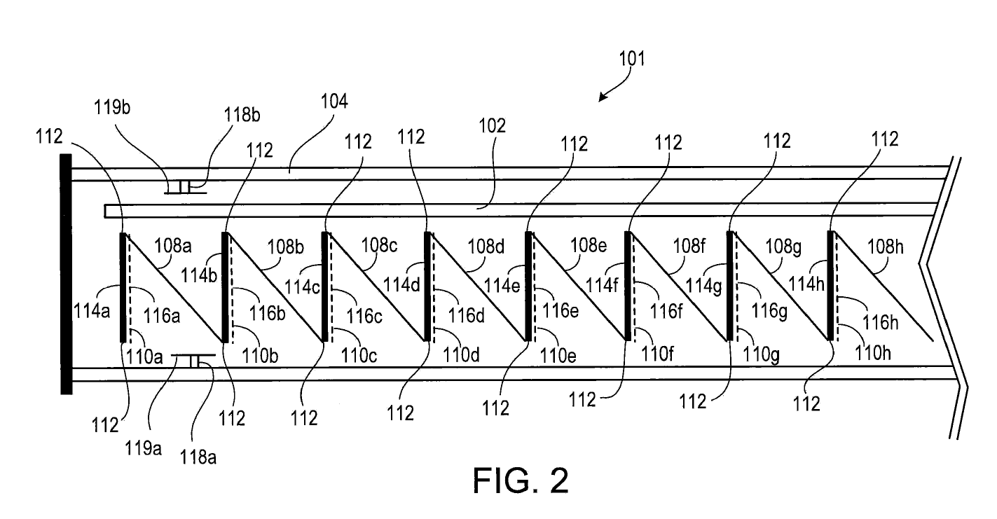

FIGS. 1 and 2 show an implementation of a window blind assembly 101 in the frame 103 of a window. As discussed in detail below, when extended across the window, as shown, the window blind assembly can enable a person inside the room to see out through the window blind assembly and simultaneously prevent a different person outside the room from seeing in through the window blind assembly 101. This effect can be achieved regardless of the ambient illumination levels inside and outside the room.

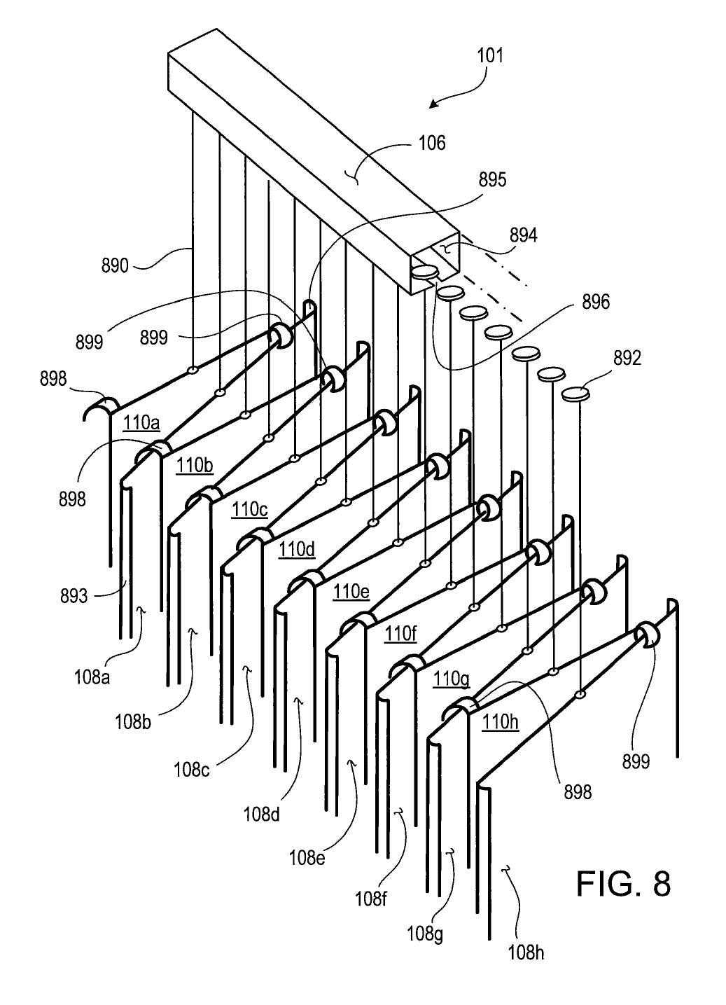

The window blind assembly 101 includes a support element 106, which is coupled to the top of the window frame 103, and alternating first 108a-108l and second 110a-110l slats extended from the support element 106 in a downward direction. The support element is also a guide to control how the slats are deployed in going from a folded to extended state, as illustrated, for example, in FIGS. 8, 9 and 10. The first 108a-108l and second 110a-110l slats span across substantially the entire height of the window 104. Indeed, the bottoms of the slats are only a short distance above the bottom of the window frame 103.

In the illustrated implementation, adjacent first and second slats (e.g., first slat 108a and second slat 110b) are connected to one another with hinged connections 112 (as in FIG. 10). The first 108a-108l and second 110a-110l slats are able to rotate freely about the hinged connections 112.

Each second slat 110a-110l lies in a plane that is approximately perpendicular to the window 104. The first slats 108a-108l are angled relative to the second slats 110a-110l. Except for first slat 108l at the end of the window blind assembly 101, each first slat 108a-108k extends diagonally from a first end of a first one of the adjacent second slats to an opposite end of a different one of the adjacent second slats. As an example, first slat 108a extends diagonally between one end (near the window) of second slat 110a to an opposite end (near the room) of second slat 110b. The series of alternating first 108a-108b and second 110a-110b slats thereby form, in plan view, a saw tooth pattern, as best seen in FIG. 2. In a typical implementation, with the slats in a fully opened position, as shown, adjacent first and second slats form an angle no greater than about 45°.

Each first slat and each second slat has a pair of major surfaces that face in opposite directions from one another. The major surfaces may be substantially flat or curved. The major surfaces typically are substantially smooth, however, in some implementations, may include a variety of surface features, including ridges, indentations, grooves and the like. The major surfaces are typically rectangular in shape. The length of each major surface is about as long as the slats themselves and the width of each major surface is substantially wider than the edges (which extend between major surfaces) of the slats.

In the illustrated implementation, the first slats 108a-108l are semi-mirrored and semi-transparent. In a typical implementation, the first slats 108a-108l may be formed from a rigid, substantially transparent material, such as glass or plastic, and have a coating of reflective material sparsely, but substantially evenly applied to each major surface thereof. Typically, the reflective material is applied in an amount sufficient to render the first slats 108a-108g substantially reflective under certain ambient lighting conditions, but substantially transparent under other ambient lighting conditions. The first slats 108a-108g, therefore, generally behave as two-way mirrors, appearing either substantially transparent or substantially mirrored, depending on the relative lighting levels in front of and behind each first slat.

The second slats 110a-110l are not transparent. In the illustrated implementation, each second slat 110a-110l has two major surfaces (i.e., a first major surface 114a-114l and a second major surface 116a-116l) that face opposite directions. In a typical implementation, the first major surfaces 114a-114l are a lighter color than the second major surfaces 116a-116l. Both major surfaces typically are matte.

Aside from the second slat 110a at the end of the series of slats, all of the second slats 110b-110l are arranged so that their respective light-colored, first major surfaces 114b-114l are facing generally toward an associated one of the partially reflective first slats 108a-108k. This arrangement results in light reflected by each of the light-colored, first major surfaces 114b-114l being reflected by the partially reflective first slats 108a-108k in a first direction (i.e., through the window 104). The second slats 110a-110l also are arranged so light reflected by the darker, second major surfaces 116a-116l is reflected by respective adjacent first slats 108a-108l in a second direction different from the first direction (i.e., into the room).

Since the first major surfaces 114a-114l are lighter in color than the darker second major surfaces 116a-116l, they tend to reflect a greater percentage of incident light than do the second major surfaces 116a-116l. In a typical implementation, the first major surfaces 114a-114l are white and the second major surfaces 116a-116l are black.

The source of illumination 102 is operable to provide the first major surfaces 114a-114l with a sufficient amount of illumination relative to the ambient lighting conditions inside the room that a person standing outside the window 104 and looking in would see mostly just the reflections of the illuminated, lighter first major surfaces 114a-114l instead of the inside of the room. Furthermore, with the first major surfaces 114a-114l so illuminated, a person standing inside the room and attempting to look out, the second slats would appear substantially transparent. This effect helps facilitate privacy for the person in the room without requiring that they block their view to the outside world.

In the illustrated implementation, the source of illumination 102 is below the slats and offset a bit toward the window relative to the slats. The source of illumination 102 is angled so that a great amount of its illumination is directed toward the first major surfaces of the second slats. The illustrated source of illumination 102 is mounted directly to the window frame and has a slightly greater width than the width of the entire series of slats. The source of illumination 102 is arranged approximately parallel to the window 104 and to a widthwise dimension of the window blinds. Suitable sources of illumination 102 include, for example, fluorescent, neon and incandescent light fixture.

In the illustrated implementation, the source of illumination 102 is adjustable depending on the relative ambient lighting condition inside the window blinds assembly 101 as compared to outside the window blinds assembly 101. If, for example, the ambient light outside the window blind assembly is very bright from the sun and the ambient light inside the room is dim, then the source of illumination 102 may be dimmed or completely extinguished. This is because, under those relative ambient lighting conditions, the desirable effect of being able to see out through the window blind assembly 101, but not being able to see in would occur without the influence of the source of illumination 102.

Ambient light sensor 118a, 118b are provided to sense the ambient light levels both inside and outside the room. More particularly, the ambient light sensors 118a, 118b provide an indication as to how the ambient light level inside the room (e.g., from lamps, etc.) compares to the ambient light outside the room (e.g., from the sun, etc.). The source of illumination 102 may be automatically adjusted according to the outcome of this comparison. For example, if the room's ambient light condition is brighter than outside the window, then the source of illumination 102 may be set to provide a high level of illumination to the first major surfaces of the second slats. This is because, without such illumination from the source of illumination 102, if the room is brighter than the outside, then a person standing outside may be able to see through the first slats and into the room. With the first major surfaces of the second slats sufficiently illuminated by the source of illumination 102, a person inside the room can see out through the window blind assembly, but a person outside the room would be substantially blocked from seeing into the room.

Since the ambient light sensors 118a, 118b are intended to sense ambient light conditions in different places, they generally should be arranged so that they are exposed to the ambient light conditions appropriately. For example, in the illustrated implementation, non-transparent shields 119a, 119b are provided adjacent the sensors 118a, 118b to ensure that sensors are only exposed to light from either inside or outside the window blinds. For example, shield 119a shields sensor 118a from ambient light conditions outside the window. Similarly, shield 119b shields sensor 118b from ambient light conditions inside the room.

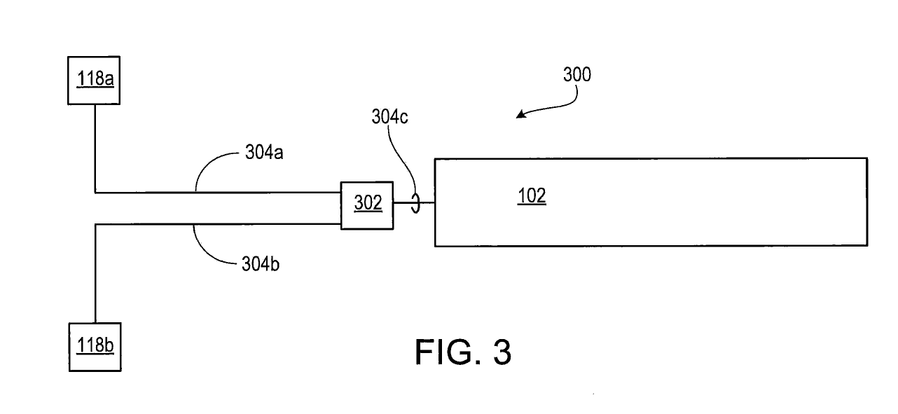

FIG. 3 illustrates a circuit diagram showing one implementation of a control system 300 for the source of illumination 102.

In the illustrated implementation, the ambient light sensors 118a, 118b are coupled to a computerized processing unit 302 via communications media 304a, 304b, which, in the illustrated embodiment is a pair of wires. The computerized processing unit 302 is coupled to the source of illumination 102.

In a typical implementation, data from the ambient light sensors 118a, 118b is transmitted via over respective communication media 304a, 304b to the computerized processing unit 302. The data transmitted is indicative of the sensed ambient light conditions at the respective locations of the ambient light sensors. The computerized processing unit 302 processes the data to compare the relative ambient lighting conditions inside the room as compared to outside the window. Based on this comparison, the computerized processing unit 302 determines how much, if any, illumination the source of illumination 102 should provide to the second slats 110a-110l. Then, via communication media 304c, the computerized processing unit 302 controls the source of illumination 102 to provide an appropriate amount of illumination.

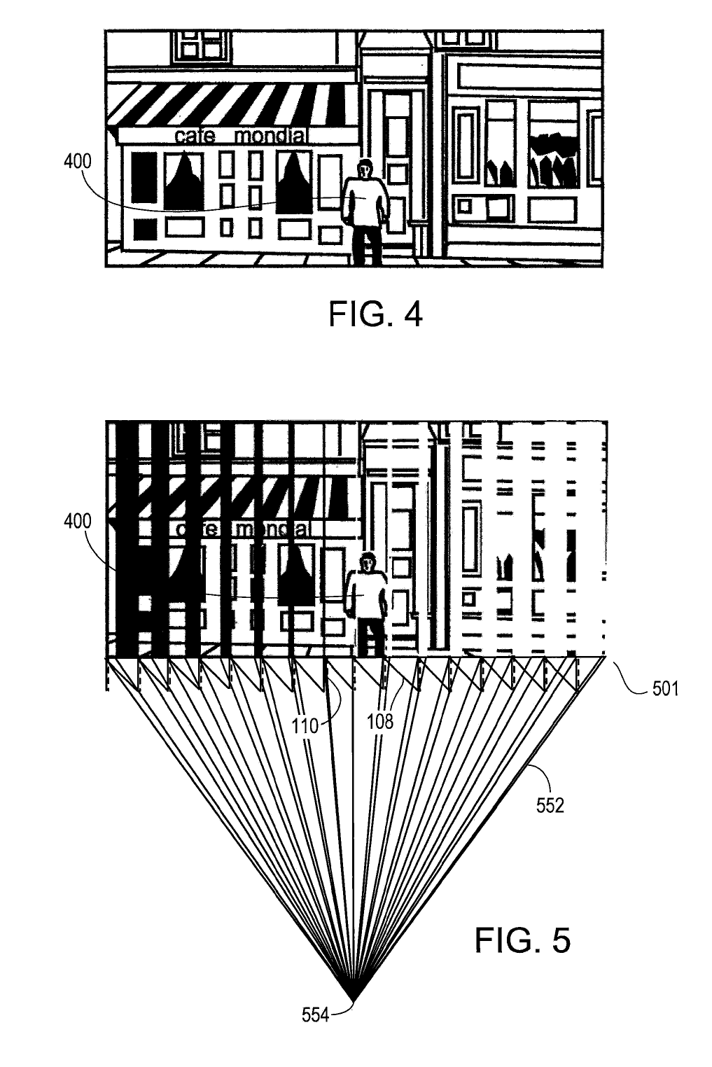

FIG. 4 shows a view from a room looking out through a window. In the illustrated implementation, there is no window blind assembly in the window. The view includes a person 400 standing in front of an urban landscape that includes a café and other structures.

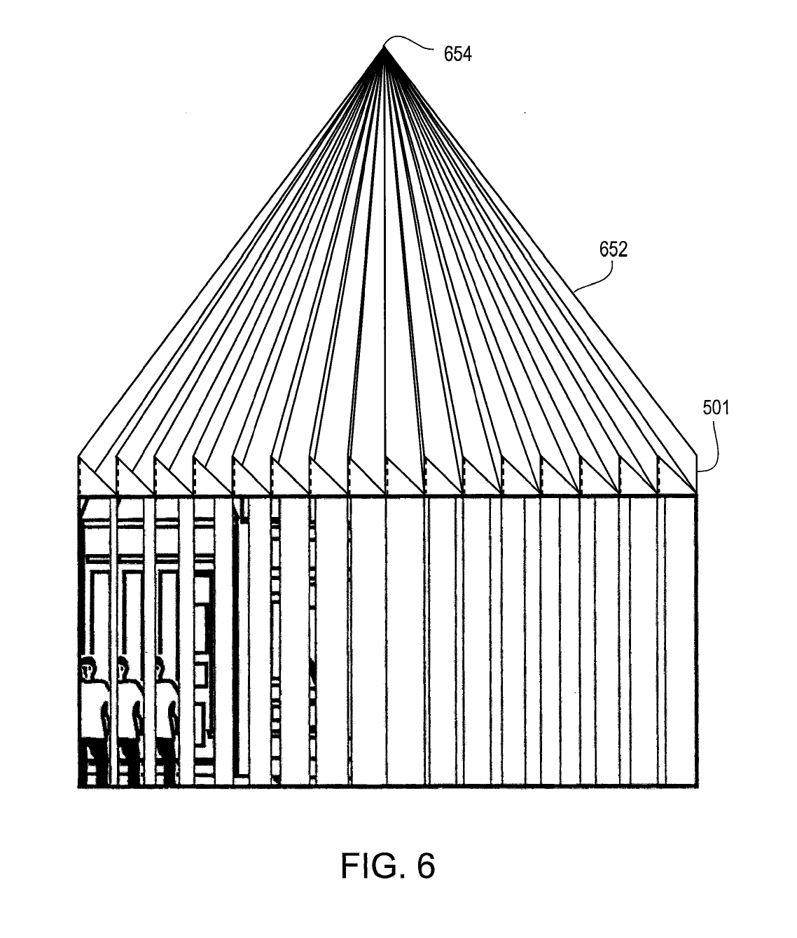

FIG. 5 shows the same view as in FIG. 4 except that, in FIG. 5, the view is being seen through a window blind assembly 501, which is similar in structure to the window blind assembly 101 of FIG. 1. Also, the bottom part of FIG. 5 shows a cross-sectional top view of the window blinds assembly 501 indicating the locations of the various slats relative to the view being seen as well as lines 552 of sight that extend from a viewing point 554 (inside the room approximately directly in front of the middle of the window) to the slats.

In the illustrated implementation, the view is shown as it would appear if, for example, it were brighter inside the room than outside the room, but still bright enough to see outside the room. As is shown in FIG. 5, the view through the window blind assembly 501 is not completely unobstructed. This is because, although the first slats 108 are transparent, the second slats 110 are not transparent. Therefore, depending on the viewing angle, certain portions of the view will be obstructed by parts of the non-transparent second slats.

In the illustrated example, the viewing point 554 is essentially directly in front of the center of the window. From that viewing point 554, the middle portion of the view (i.e., near the person 400) appears substantially unobstructed. This is because at the middle portion of the view, which is about straight in front of the viewing point 554, the non-transparent second slats 110 are approximately perpendicular to the lines of sight 552. Most of what the viewer sees in the middle portion, therefore, is the first slats 108, which appear substantially transparent.

As the lines of sight 552 change from the middle portion of the view towards the left portion of the view (i.e., toward the café and beyond), more and more of the dark surfaces of the second slats becomes visible. Therefore, as the viewing angle increases in this direction, more and more of the view is obstructed by vertical dark bands.

Similarly, as the lines of sight 552 change from the middle portion of the view towards the right portion of the view (i.e., in a direction opposite the café), more and more of the light surfaces of the second slats (which are visible through the transparent first slats) become visible. Therefore, as the viewing angle increases in this direction, more and more of the view is obstructed by light-colored vertical lines.

Despite the obstructions shown, a person standing inside the room and looking out through the closed blinds would still be able to see a considerable amount of the view outside the window.

FIG. 6 shows a view that the person 400 of FIG. 4 would see attempting to look in through the window blind assembly 501.

The top part of FIG. 6 shows a cross-sectional top view of the window blinds assembly 501 indicating the locations of the various slats relative to the view being seen as well as lines 652 of sight that extend from a viewing point 654 (outside the window blinds assembly and approximately directly in front of the middle of the window) to the slats.

As is shown in FIG. 6, the view into the room, through the window blind assembly 501, is completely obstructed. This is because the second slats are not transparent and, from the outside, with the source of light illuminating the second slats, the first slats 108 are reflective (i.e., not transparent). Depending on the viewing angle, the person sees either a portion of the non-transparent second slats, a reflection of the light-colored, non-reflective major surfaces of the second slats, or a reflection of him or herself in the first slats. At no point across the slats, can the interior of the room beyond the slats be seen.

In the illustrated example, the viewing point 654 is essentially directly in front of the center of the window. From that viewing point 654, the middle portion of the view is substantially all white. This is because the viewer sees first slats reflecting the light-colored, illuminated first major surfaces of the second slats.

As the line of sight 652 moves to the left of center in the figure, the person looking at the window blind sees fractured reflections of him or herself. This is because the angle of the first slats in this portion of the assembly is such that it reflects directly back toward the viewer. The reflections are fractured by slivers of reflected portions of the illuminated first major surfaces of the second slats in this area. The further toward the edge of the slats the viewer looks, the more the viewer's reflection is revealed.

As the lines of sight move to the right in the figure, more and more of the white, illuminated first major surfaces of the second slats is revealed.

In the illustrated figure, it can be seen that regardless of where on the window blinds a person outside looks, their view to the inside is blocked.

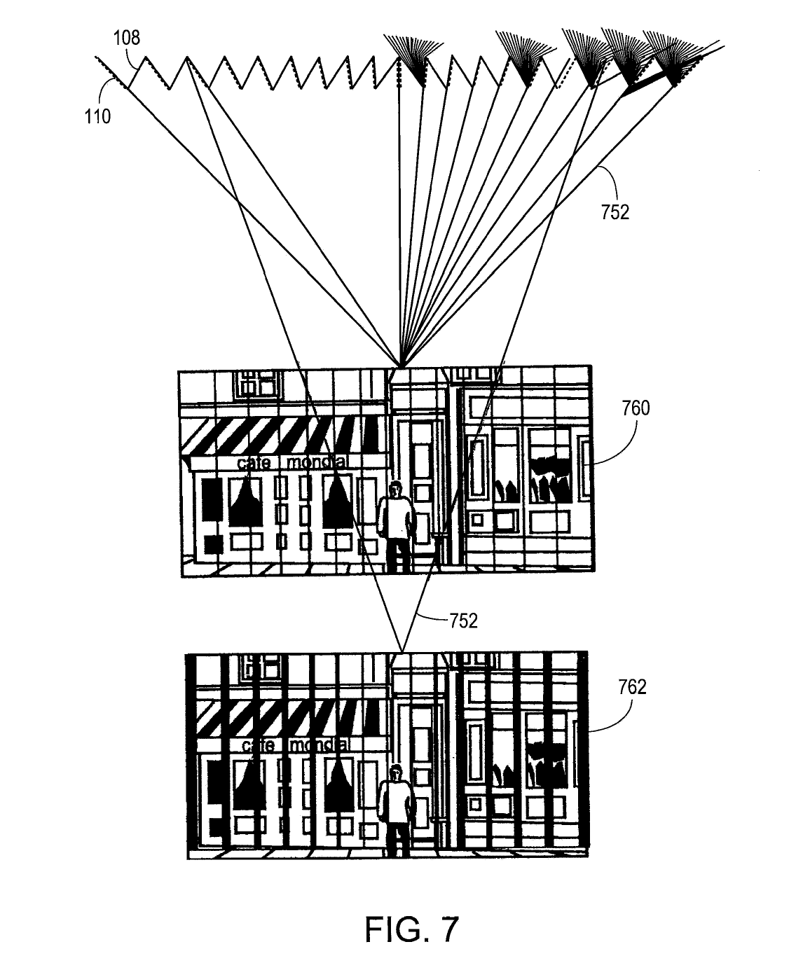

FIG. 7 shows a cross-sectional plan view of a window blind assembly 701 and the views looking out through the slats from two distances, a closer distance 760 and a farther distance 762 from the window blind assembly 701.

When viewed from the closer distance 760, the view to the outside is substantially unobstructed or uninterrupted. This is because each of the non-transparent, second slats 110 lies in substantial alignment with the lines of sight 752 when viewed from the closer distance 760. Accordingly, at no point along the width of the view, is the view substantially blocked by the second slats. From distance 760, each of the first slats 108 can be looked through pretty clearly.

When viewed from the farther distance 762, the view to the outside is more obstructed than the view from the closer distance 762. This is because, when viewed from the farther distance 762, not all of the second slats 110 are substantially aligned with the lines of sight 752. Accordingly, certain parts, particularly those at the outer portions of the view, are obstructed.

This figure illustrates that the angles of the first and second slats relative to one another can vary across the window blind assembly. This may provide a substantially unobstructed view out through the window blind assembly when viewed from a certain distance. This feature may be particularly advantageous in window blind applications, such as in kiosks, where a clear, unobstructed view to the outside from a particular spot inside, is particularly desirable.

FIG. 8 is a partial perspective view illustrating a top portion of a window blind assembly 801.

In the illustrated implementation, the first 108 and second 110 slats are suspended from the support element 106 by wires 890, which in FIG. 8 are shown as being longer than they likely would be in order to show other features of the implementation.

Buttons 892 are coupled to the upper ends of the wires 890 and are sized to mate with a channel 894 in the support element 106. An opening 896 extends lengthwise along the bottom of support element 106 permitting the wires 890 to extend from the buttons 892 inside the channel 894 down to the slats. The buttons 892 are adapted to be able to slide in a lengthwise direction within the channel 894. Movement of the buttons 892 in this manner facilitates opening and closing of the window blind assembly across the window.

In the illustrated implementation, a pair of hooks 898, 899 extend in opposite directions and from opposite ends of each second slat 110. Hooks 898 are configured to engage an upper edge of an adjacent one of the first slats 108 on a first side of each second slats 110. Hooks 899 are configured to engage an upper edge of an adjacent one of the first slats 108 on a first side of each second slats 110. The hooks 898, 899 engage the respective upper edges of the adjacent first slats in a way that enables the hooks to slide along the upper edges. The hooks 898, 899, however, help maintain the ends of adjacent first 108 and second 110 slats close to one another.

Additionally, in the illustrated implementation, the front 893 and back 895 sides of the first slats 108 are curved toward the adjacent second slats 110 that they are closest to. The curves help prevent a person on either side of the slats from seeing through openings between the slats.

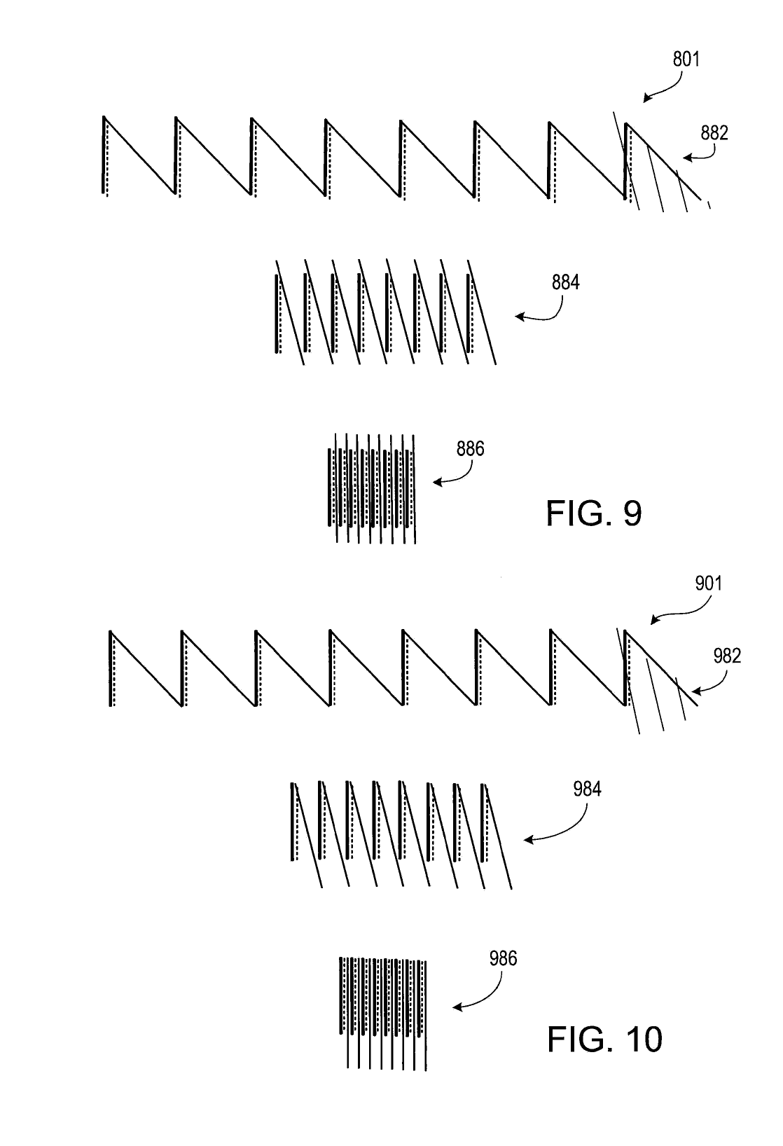

FIG. 9 shows a cross-sectional view of a collapsible window blind assembly (e.g., 801) shown in three stages 882, 884, 886 of collapse.

At 882, the window blind assembly 801 is shown in a fully open configuration. As illustrated, the second slats 110 are disposed approximately parallel to one another and approximately perpendicular to a lengthwise dimension of the extended window blind assembly 801. The second slats also are parallel to one another and form an angle of about 45° relative to adjacent first slats. The ends of adjacent first and second slats are substantially in contact with one another other.

At 884, the window blind assembly 801 is shown partially collapsed. The ends of the first and second slats have moved apart. The second slats remain substantially parallel to one another and substantially perpendicular to the lengthwise dimension of the extended window blind assembly 801. The angle between adjacent first and second slats has reduced as compared to the same angle at 882. The ends of the first slats extend beyond the ends of the second slats. The ends of the second slats remain in substantially close contact with adjacent first slats.

At 886, the window blind assembly is shown in a fully collapsed position. All of the first and second slats are substantially parallel to one another and substantially perpendicular to the lengthwise dimension of the extended window blind assembly 801. Adjacent first and second slats are in substantially close contact with one another. Ends of the second slats extend beyond both ends of the first slats.

FIG. 10 is a similar to FIG. 9 in that it shows a cross-sectional view of a collapsible window blind assembly 901 shown in three stages 982, 984, 986 of collapse.

The window blind assembly 901 of FIG. 10 differs from the window blind assembly 801 of FIG. 9 because adjacent first and second slats are secured to one another at one end thereof.

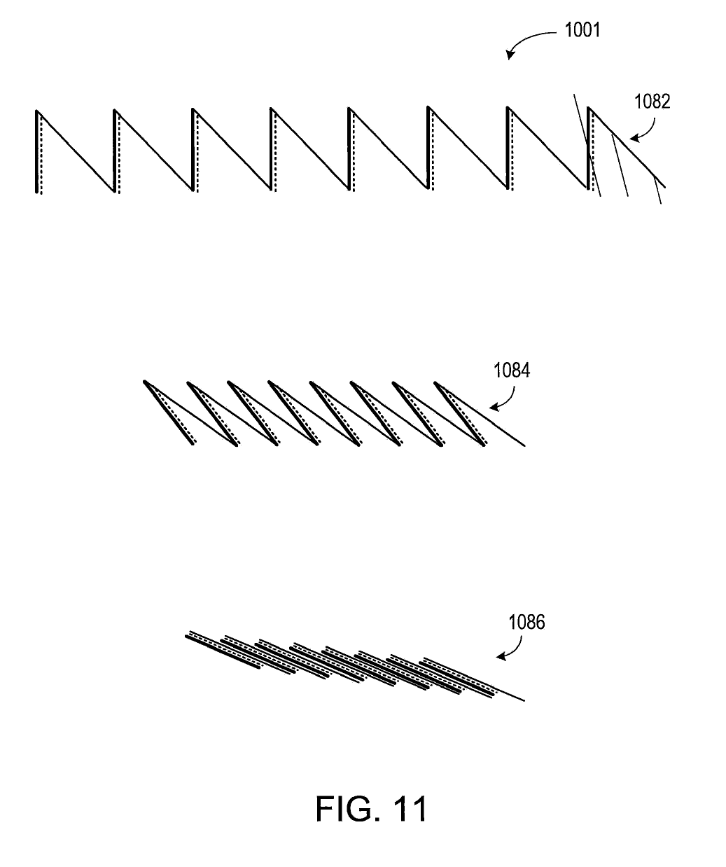

FIG. 11 is similar to FIG. 10 in that it shows a cross-sectional view of a collapsible window blind assembly 1001 shown in three stages 1082, 1084, 1086 of collapse.

The window blind assembly 1001 of FIG. 11 differs from the window blind assembly of FIG. 10 because adjacent first and second slats are secured to one another at both ends.

A number of embodiments of the invention have been described. Nevertheless, it will be understood that various modifications may be made without departing from the spirit and scope of the invention. For example, the slats could be configured, like Venetian blinds, to extend horizontally, instead of vertically, across the window.

A variety of control features may be implemented to control the amount of illumination to be provided by the source of illumination. For example, the angle of tilt or position of the source of illumination may be adjustable. The adjustability may be automated to maximize the effect of the illumination. Similarly, the angular relationship between adjacent slats may be adjustable as well. This adjustability may be automated as well to maximize the effect of the illumination.

Various control features may be implemented manually. For example, the light fixture may be controllable from a simple switch. The switch may be wall mounted or mounted at the window frame.

The source of illumination may be any one of a variety of different light sources. The source of illumination may be positioned outside the window, for example, on the lawn of a house and be directed at the window blind assembly. The source of illumination can be above the window blind assembly and directed downward or placed on either side of the window blind assembly and directed at the window blind assembly. Indeed, the source of illumination could be integrated into the slats of the window blind assembly itself.

The size of the slats and materials to manufacture the slats and other elements may be modified. The slats may be configured so that the first and second slats are angled relative to one another in any of a number of ways. However, in a typical implementation, the angle between the first and second slats is less than about 45°.

The window blind assembly may be sold as either different parts or as a pre-assembled unit. In some implementations, the window blind assembly may be sold with a rectangular frame element and a pair of glass panes supported by the frame element and defining an interior space for containing the support element, the slats, the source of illumination, the ambient light sensors, shields and computerized control unit, and/or appropriate mechanisms for manipulating and operating the window blind assembly from outside the frame/panes.

The ambient light sensors and associated control circuitry is optional. The shields are optional. Indeed, in some implementations, the source of illumination may be considered optional.

Other embodiments are within the scope of the claims.

What is claimed is:

1. A window blind assembly comprising:
alternating first and second slats, the first slats being semi-mirrored and semi-transparent;
a source of illumination to illuminate first major surfaces of the second slats;
wherein the first and second slats are arranged so that light reflected by the first major surfaces of the second slats is at least partially reflected, in a first direction, by the first slats.

2. The window blind assembly of claim 1 wherein the first slats are arranged relative to the second slats so that the reflected by the second major surfaces of the second slats, opposite the first major surfaces, is at least partially reflected by the first slats in a second direction that is different from the first direction.

3. The window blind assembly of claim 2 wherein the first major surfaces are lighter in color than the second major surfaces.

4. The window blind assembly of claim 1 wherein the source of illumination is arranged to illuminate the first major surfaces of the second slats so that the first slats to appear substantially reflective when viewed from the first direction and to cause the first slats to appear substantially transparent when viewed from a second direction.

5. The window blind assembly of claim 1 wherein the source of illumination is a lighting fixture.

6. The window blind assembly of claim 1 wherein the amount of illumination provided by the source of illumination is adjustable.

7. The window blind assembly of claim 6 wherein the amount of illumination provided by the source of illumination is automatically adjustable based on ambient lighting conditions at one side of the window blind assembly.

8. The window blind assembly of claim 7 wherein the adjustability is based on ambient lighting conditions at one side of the window blind assembly relative to ambient lighting conditions at an other side of the window blind assembly.

9. The window blind assembly of claim 7 further comprising one or more sensors to sense the ambient lighting conditions.

10. The window blind assembly of claim 1 wherein adjacent first and second slats are substantially in contact with one another.

11. The window blind assembly of claim 1 wherein adjacent first and second slats are connected to one another via hinged connections.

12. The window blind assembly of claim 1 wherein adjacent first and second slats, in their deployment, are at angles that a support element controls.

13. The window blind assembly of claim 1 wherein each first slat is arranged substantially perpendicular to a lengthwise axis of the window blind assembly and wherein at least some of the second slats extend from a first end of one of the first slats to a second, opposite end of a different one of the first slats.

14. The window blind assembly of claim 13 wherein adjacent first and second slats form an angle relative to one another that is less than 45°.

15. A window blind assembly comprising:
alternating first and second slats, the first slats being semi-mirrored and semi-transparent; and
the second slats having respective first and second surfaces,
wherein the first surfaces are lighter in color than the second surfaces, and
wherein the first slats are arranged relative to the second slats so that light reflected by the first surfaces of the second slats is at least partially reflected, in a first direction, by the first slats.

16. The window blind assembly of claim 15 further comprising a light fixture to illuminate the first surfaces of the second slats.

17. The window blind assembly of claim 15 wherein the first slats are arranged relative to the second slats so that the second surfaces of the second slats are at least partially reflected by the first slats in a second direction that is different from the first direction.

18. The window blind assembly of claim 15 wherein adjacent first and second slats form an angle relative to one another that is less than 45°.

19. The window blind assembly of claim 15 wherein the first and second surfaces face in opposite directions from one another, are rectangular in shape, and have widths substantially wider than edges of the slats, which extend between the first and second surfaces.

20. A window blind assembly comprising:
a support element coupled to a window frame;
alternating first and second slats extending from the support element across the window, the first slats being semi-mirrored and semi-transparent, and the second slats having first and second major surfaces,
wherein the first major surfaces are lighter in color than the second major surfaces;
a lighting fixture to illuminate the first major surfaces of the second slats;
wherein the first and second slats are arranged so that light reflected by the first major surfaces of the second slats is at least partially reflected, in a first direction, by the first slats;
wherein the first and second slats are further arranged so that light reflected by the second major surfaces of the second slats is at least partially reflected, in a second direction opposite the first direction, by the first slats; and
wherein adjacent first and second slats form an angle relative to one another that is less than 45°.
